(19) United States
(12) Patent Application Publication
(10) Pub. No.: US 2020/0388098 A1
(43) Pub. Date: Dec. 10, 2020

(54) BANKNOTE HANDLING APPARATUS AND BANKNOTE HANDLING METHOD

(71) Applicant: GLORY LTD., Hyogo (JP)

(72) Inventors: Kenichiro AKITA, Hyogo (JP); Tsuyoshi HOJO, Hyogo (JP); Hitoshi UENO, Hyogo (JP)

(73) Assignee: GLORY LTD., Hyogo (JP)

(21) Appl. No.: 16/628,431

(22) PCT Filed: Jul. 6, 2017
(86) PCT No.: PCT/JP2017/024838

§ 371 Date: Mar. 3, 2020

(51) Int. Cl. G07D 7/0047; G07D 11/14; G07D 11/18; G07D 7/1205

(52) U.S. Cl. CPC G07D 7/0047; G07D 11/14; G07D 2211/00; G07D 7/1205; G07D 2207/00; G07D 11/18

(57) ABSTRACT

In order to meet a demand for banknote handling using serial numbers, a banknote handling apparatus is provided with a recognition unit configured to read a serial number of a banknote, and a control unit configured to determine a first type, of the banknote, related to the serial number, based on the serial number read by the recognition unit, and determine a second type, of the banknote, related to authenticity and fitness, based on the first type.

### TECHNICAL FIELD

The present invention relates to a banknote handling apparatus and a banknote handling method for handling banknotes based on serial numbers.

### BACKGROUND ART

Conventionally, banknote handling apparatuses for handling banknotes based on serial numbers of the banknotes have been used. For example, Patent Literature 1 discloses a banknote handling apparatus in which a banknote is handled in different manners depending on whether or not the serial number of the banknote is registered on a serial number information list. This banknote handling apparatus executes, for example, a depositing process in which banknotes received at an inlet/outlet are recognized and stored in the apparatus, and a dispensing process in which banknotes stored in the apparatus are discharged to the inlet/outlet.

When the serial numbers of counterfeit notes have been identified, these serial numbers are registered on the serial number information list in advance. When a serial number read from a banknote by the banknote handling apparatus matches any of the serial numbers registered on the serial number information list, this banknote is likely to be a counterfeit note. Therefore, the banknote handling apparatus handles banknotes in different manners depending on whether or not the serial number read from each banknote matches any of the serial numbers on the serial number information list.

In the depositing process, the banknote handling apparatus stores, in a banknote storage, a banknote whose serial number does not match any of the serial numbers on the serial number information list and which is reusable as a banknote for dispensing in the dispensing process. Meanwhile, since a banknote whose serial number matches any of the serial numbers on the serial number information list is not reusable for dispensing, this banknote is stored in a reject storage that stores damaged banknotes, banknotes not reusable for dispensing, etc.

### CITATION LIST

### Patent Literature

[PTL 1] Japanese Laid-Open Patent Publication No. 2015-191501

### SUMMARY OF THE INVENTION

### Problems to be Solved by the Invention

In the conventional art described above, the banknote handling method using serial numbers is limited. Specifically, when a banknote is recognized to determine the type thereof, the serial number of the banknote is used just for comparison with the serial number information list. In addition, when sorting banknotes by types, banknotes, whose serial numbers having been read are determined to be registered on the serial number information list, are all transported to the reject storage. Therefore, the conventional apparatus cannot meet a demand for using the serial number reading result for determination of fit/unfit, and a demand for sorting banknotes into a plurality of types based on the serial number reading result.

The present invention is made to solve the problems of the conventional art, and an object of the present invention is to provide a banknote handling apparatus and a banknote handling method which can meet the demands for banknote handling using serial numbers.

### Solution to the Problems

In order to solve the above problems and achieve the object, a banknote handling apparatus according to the present invention includes: a recognition unit configured to read a serial number of a banknote; and a control unit configured to determine a first type, of the banknote, related to the serial number, based on the serial number read by the recognition unit, and determine a second type, of the banknote, related to authenticity and fitness, based on the first type.

In the above invention, the banknote handling apparatus further includes a memory unit configured to store therein correspondence between a plurality of first types and a plurality of second types. The control unit is configured to determine a first type, among the plurality of first types stored in the memory unit, to which the banknote whose serial number has been read by the recognition unit corresponds, thereby determining the second type of the banknote.

In the above invention, the memory unit is configured to further store therein priority orders of the first types. When the banknote whose serial number has been read by the recognition unit corresponds to a plurality of the first types, the control unit is configured to select one of the first types based on the priority orders, thereby determining the second type of the banknote.

In the above invention, the memory unit is configured to further store therein priority orders of the second types. When the banknote whose serial number has been read by the recognition unit corresponds to a plurality of the first types so that the single banknote is sorted into a plurality of the second types, the control unit is configured to determine one of the second types based on the priority orders.

In the above invention, the banknote handling apparatus further includes an operation unit configured to set correspondence between the first types and the second types.

In the above invention, the first types include a type indicating that the serial number of the banknote matches a serial number included in a serial number list prepared in advance.

In the above invention, the first types include a type indicating that a plurality of serial numbers printed on a single banknote include a serial number different from the other serial numbers.

In the above invention, the first types include a type indicating that characters have not been ascertained at one or more digits of the serial number and the number or positions of the digits at which the characters are uncertain satisfies a predetermined condition.

In the above invention, the second types include a type indicating a genuine and fit note, a type indicating a genuine and unfit note, and a type indicating a counterfeit note.

In the above invention, the second types further include a type indicating a reject note.

In the above invention, the second types further include a type indicating a suspect note.

In the above invention, the recognition unit is configured to further recognize a feature, of the banknote, other than the serial number. The control unit is configured to determine the second type of the banknote, based on the feature other than the serial number, the feature having been recognized by the recognition unit.

In the above invention, when the second type determined based on the first type of the banknote is different from the second type determined based on the feature, of the banknote, other than the serial number, the control unit is configured to determine the second type of the banknote based on priority orders of the second types.

In the above invention, the control unit is configured to determine the second type based on the feature other than the serial number, and thereafter, performs a recognition process of determining the second type based on the first type.

In the above invention, the recognition unit is configured to recognize an optical feature, of the banknote, which is the feature other than the serial number by using a captured image of the banknote.

In the above invention, the banknote handling apparatus further includes: an inlet unit in which banknotes are inserted; a plurality of discharge units through which banknotes are discharged; and a transport unit configured to transport banknotes, the transport unit connecting the insertion unit to the discharge units. The control unit is configured to control, based on the second type, the transport unit so as to transport the banknotes inserted from the inlet unit to any of the plurality of discharge units.

A banknote handling method according to the present invention is a method of sorting banknotes, for each type, by a banknote handling apparatus. The method includes: reading a serial number of a banknote; determining a first type of the banknote, based on the read serial number of the banknote; and determining a second type, of the banknote, related to authenticity and fitness, based on the first type.

### Advantageous Effects of the Invention

According to the banknote handling apparatus of the present invention, it is determined which one of a plurality of first types prepared in advance, corresponds to a reading result of a serial number read from a banknote. Then, based on the determination result, it is determined which one of a plurality of second types that are related to authenticity and fitness and prepared in advance, corresponds to the type of the banknote. Since correspondence between the first types based on the serial number reading result and the second types related to authenticity and fitness is set, various ways to handle banknotes based on the serial number can be realized.

### BRIEF DESCRIPTION OF THE DRAWINGS

FIGS. 1A to 1E schematically illustrate a banknote handling apparatus and a banknote handling method according to the present embodiment.

FIG. 2 is a perspective view of an outer appearance of a money handling system including the banknote handling apparatus.

FIG. 3 is a schematic diagram showing an internal configuration of the banknote handling apparatus.

FIG. 4 is a block diagram schematically showing a functional configuration of the money handling system.

FIG. 5 is a flowchart showing a process of determining a type of a banknote in a secondary recognition process.

FIGS. 6A and 6B show examples of settings used in the secondary recognition process.

FIG. 7 shows examples of patterns prepared as transport settings.

FIG. 8 shows examples of patterns prepared as settings for the secondary recognition process.

FIG. 9 is a flowchart showing a process of determining the second type of a banknote related to authenticity and fitness, through a primary recognition process and a secondary recognition process.

FIG. 10 shows a relationship between a determination result of the second type of a banknote in the primary recognition process and a determination result of the second type of the banknote in the secondary recognition process.

FIG. 11 shows examples of second types of banknotes, each having two serial numbers printed at left and right sides, determined in the secondary recognition process.

FIGS. 12A to 12D show the types of banknotes finally determined based on the second types of the banknotes determined in the primary recognition process and the second types of the banknotes determined in the secondary recognition process.

FIGS. 13A and 13B show examples of settings for determining the second types of banknotes according to the number and positions of uncertain digits.

FIGS. 14A and 14B show examples of settings for determining the second types of banknotes according to the number and positions of digits that have not matched when a plurality of serial numbers were compared.

FIG. 15 shows another example of a banknote handling apparatus capable of executing the secondary recognition process.

FIG. 16 shows still another example of a banknote handling apparatus capable of executing the secondary recognition process.

### DESCRIPTION OF EMBODIMENTS

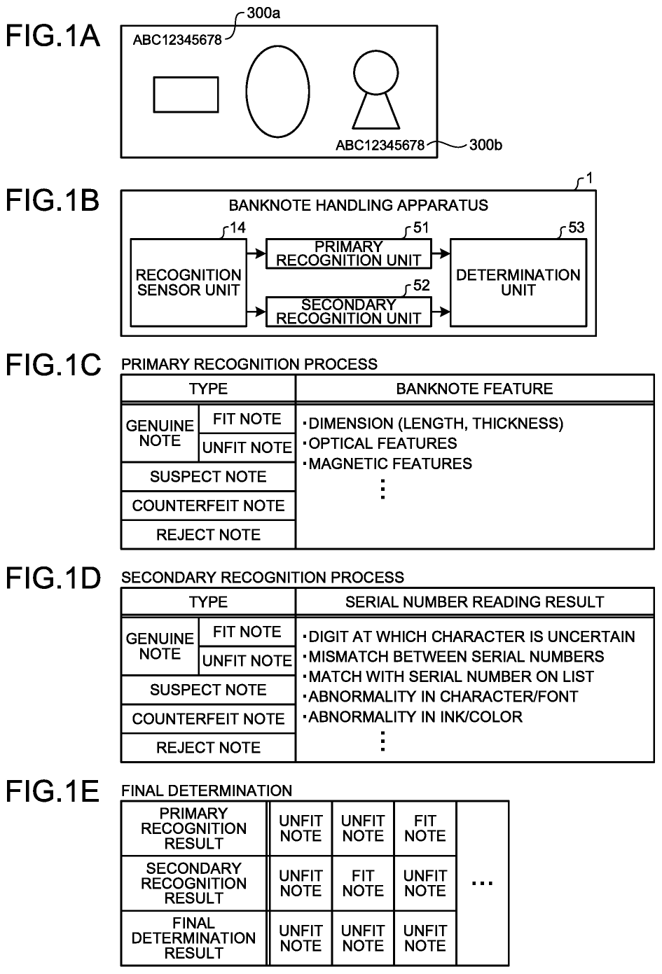

Hereinafter, a banknote handling apparatus and a banknote handling method according to the present invention will be described in detail with reference to the accompanying drawings. First, the banknote handling apparatus and the banknote handling method will be schematically described. FIGS. 1A to 1E schematically illustrate the banknote handling apparatus and the banknote handling method according to an embodiment of the present invention. A banknote on which a plurality of serial numbers 300 (300a, 300b) are printed as shown in FIG. 1A is handled by a banknote handling apparatus 1 shown in FIG. 1B. The banknote handling apparatus 1 recognizes the banknote by using a recognition sensor unit 14 including various sensors such as a line sensor, a thickness sensor, and a magnetic sensor. The banknote handling apparatus 1 determines the type of the banknote.

Specifically, the banknote handling apparatus 1 acquires feature information and an image of the banknote by the recognition sensor unit 14, and performs two types of recognition processes, i.e., a recognition process by a primary recognition unit 51 and a recognition process by a secondary recognition unit 52. The primary recognition process is executed by the primary recognition unit 51 based on the dimension, optical features, magnetic features, etc. of the banknote, as in the conventional art. The secondary recognition process is executed by the secondary recognition unit 52 based on the serial number of the banknote.

The primary recognition unit 51 performs the primary recognition process of evaluating the feature information of the banknote acquired in the recognition sensor unit 14 to determine the type of the banknote. In the primary recognition process, the type of the banknote related to denomination, authenticity, fitness, etc. is determined. The type of the banknote is determined based on the dimensions of the banknote such as the vertical length, the horizontal length, the thickness, the optical features such as reflection characteristics and transmission characteristics of light, and the magnetic features such as changes in the magnetization direction and changes in the magnetization state.

The “denomination” is information indicating an issuer, issue year, value, etc. of a banknote. The “authenticity” is information indicating whether a banknote is a genuine banknote (genuine note) or a counterfeit banknote (counterfeit note). The “fitness” is information indicating whether a banknote is a fit note that is less stained and damaged than a predetermined criterion, or an unfit note that is stained and damaged equal to or more than the predetermined criterion. Usually, only genuine notes are subjected to evaluation of fit/unfit. For example, a criterion for banknotes that are reusable in the market is set, and banknotes are sorted into fit notes and unfit notes based on the criterion. The “optical features” are obtained when a banknote is irradiated with light such as visible light, ultraviolet light, or infrared light. The optical features include various features, which can be obtained through the irradiation with light, such as a pattern, color, characters, watermark, micro text, hologram, and security thread. The optical features of a banknote can be evaluated by use of a reflected image and/or a transmitted image of the banknote obtained by a line sensor when the banknote is irradiated with light emitted from a light source. The optical features can also be evaluated by use of a reflection spectrum and/or a transmission spectrum obtained from the banknote. The magnetic features are obtained by magnetizing a banknote. The magnetic features include features obtained through magnetization of magnetic materials such as a magnetic ink used for printing of the banknote, and a security thread. The magnetic features can be evaluated by detecting the state of magnetization of the magnetic material when a magnetizing field is applied. The magnetic features can also be evaluated by detecting changes in the magnetization direction and the magnetization state after the magnetization. Since the primary recognition process of determining the type of a banknote related to denomination, authenticity, fitness, etc., based on the dimension, optical features, magnetic features, etc. of the banknote is a conventionally known technique, detailed description thereof is omitted.

As shown in FIG. 1C, the primary recognition unit 51 determines the type of a banknote, based on the feature information of the banknote. The type (second type) of the banknote related to authenticity and fitness is determined among a genuine and fit note (hereinafter referred to as “fit note”), a genuine and unfit note (hereinafter referred to as “unfit note”), a suspect note, a counterfeit note, and a reject note.

For example, after a banknote has been determined to be a Japanese series-E 1000-yen note through denomination recognition, this banknote is subjected to authenticity recognition and fitness recognition to determine the type of the banknote related to authenticity and fitness. When the recognition result is that the banknote is a series-E 1000-yen genuine and fit note, the type of the banknote is determined to be “fit note”. When the recognition result is that the banknote is a series-E 1000-yen genuine and unfit note, the type of the banknote is determined to be “unfit note”. When the recognition result is that the banknote is a counterfeit note, the type of the banknote is determined to be “counterfeit note”. When the recognition result is that whether the banknote is a genuine note or a counterfeit note cannot be determined, the type of this banknote is determined to be “suspect note”.

When the recognition result is that the recognized object is not a banknote, this object is regarded as a reject note. For example, when the denomination of the recognized object cannot be determined and the recognition result is that the object is a sheet, such as a coupon, other than a banknote, the type of this sheet is determined to be “reject note”. The “reject note” is a type of a sheet not to be received by the banknote handling apparatus 1. The “reject note” may include specific types of banknotes related to authenticity and fitness, such as “unfit note”, “counterfeit note”, and “suspect note”, or may include notes of specific denominations. In the present embodiment, sheets other than banknotes are regarded as reject notes.

The secondary recognition unit 52 determines the type of a banknote through the secondary recognition process. In the secondary recognition process, the type of a banknote related to authenticity and fitness is determined based on a result of reading the serial number 300 of the banknote. For example, the recognition sensor unit 14 acquires an image including the serial number of the banknote, and performs optical character recognition (OCR) to read the serial number 300. In this case, the serial number reading result is a character recognition result obtained by character-recognizing the serial number 300 in the banknote image. The serial number of a banknote may be given in a code such as a barcode. In this case, the serial number reading result is a result of reading the code obtained by capturing an image of the code and analyzing information of the code in the code image. The serial number of a banknote may be stored in a memory such as an IC tag. In this case, the serial number reading result is a result of reading information stored in the memory.

In the secondary recognition process, the type (first type) of a banknote related to the serial number thereof is determined based on the reading result of the serial number 300 consisting of a plurality of digits of alphabets, numbers, etc. The first type is determined based on, for example, the number of digits and/or presence/absence of a digit at which a character or a mark cannot be ascertained. Alternatively, the first type is determined based on, for example, whether or not the reading results of the plurality of serial numbers 300a and 300b assigned to one banknote match each other. Still alternatively, when the reading result of the serial number 300 is collated with a serial number list on which serial numbers satisfying a predetermined condition are registered in advance, the first type is determined based on whether or not the reading result of the serial number 300 matches any of the serial numbers registered on the serial number list. Besides, the first type of a banknote may be determined based on, for example, the characters and marks included in the serial number, the font used for printing of the serial number, or the type or color of an ink used for printing the serial number.

After determining the first type based on the serial number reading result, the secondary recognition unit 52 determines the type (second type) of the banknote related to authenticity and fitness thereof, based on the first type as shown in (d) of FIG. 1. The second type of the banknote is determined from among “fit note”, “unfit note”, “suspect note”, “counterfeit note”, and “reject note”.

For example, a plurality of types (first types) of banknotes related to serial numbers thereof have been prepared in advance based on serial number reading results. The first types include: the number of digits, at which characters cannot be ascertained, reaching a predetermined number; a plurality of character-recognized serial numbers not matching each other; the same serial number as a serial number on the serial number list being detected; and the number of digits, character, font, or ink color being different from those of serial numbers to be printed on banknotes. In the secondary recognition process, after the type (first type) of the banknote related to the serial number has been determined, the type (second type) of the banknote related to authenticity and fitness is determined based on the determination result.

Specifically, correspondence between the types of banknotes related to serial numbers and the types of banknotes related to authenticity and fitness is set in advance. With reference to this setting, the secondary recognition unit 52 determines the type (second type) related to authenticity and fitness, based on the type (first type) related to the serial number. The specific example of the secondary recognition process will be described later.

The type of the banknote related to authenticity and fitness, which has been determined based on the feature information of the banknote through the primary recognition process executed by the primary recognition unit 51, is input to a determination unit 53 as shown in FIG. 1B. Likewise, the type of the banknote related to authenticity and fitness, which has been determined based on the serial number reading result through the secondary recognition process executed by the secondary recognition unit 52 is also input to the determination unit 53.

The banknote handling apparatus 1 can be set to execute only one of the primary recognition process and the secondary recognition process, or execute both of the processes. When the apparatus 1 is set to execute only the primary recognition process, the determination unit 53 determines the type of the banknote related to authenticity and fitness, based on the result of the primary recognition process. When the apparatus 1 is set to execute only the secondary recognition process, the determination unit 53 determines the type of the banknote related to authenticity and fitness, based on the result of the secondary recognition process.

When the apparatus 1 is set to execute both the primary recognition process and the secondary recognition process, the determination unit 53 determines the type of the banknote upon performing a final determination based on the results of the primary recognition process and the secondary recognition process as shown in FIG. 1E. Correspondence between combinations of the results of the primary recognition process and the secondary recognition process, and the types of banknotes finally determined for the respective combinations, can be set in advance.

For example, as shown in FIG. 1E, the type of a banknote determined as “unfit note” in both the primary recognition process and the secondary recognition process is finally determined as “unfit note”. The type of a banknote determined as “fit note” in the primary recognition process and as “unfit note” in the secondary recognition process is finally determined as “unfit note”. The type of a banknote determined as “unfit note” in the primary recognition process and as “fit note” in the secondary recognition process is finally determined as “unfit note”. That is, the correspondence can be set that the type of a banknote to be finally determined is the same as the type determined in the primary recognition process, or is the same as the type determined in the secondary recognition process. A specific example of the final determination will be described later.

When the type of the banknote has been finally determined by the determination unit 53 through at least one of the primary recognition process and the secondary recognition process, the banknote is transported to a corresponding destination. The banknote handling apparatus 1 includes one or more discharge outlets for discharging banknotes to the outside of the apparatus, and one or more storage units for storing banknotes in the apparatus. Correspondence between the types of banknotes and transport destinations selected from the discharge outlets and the storage units, has been prepared as transport setting in advance. The banknote, whose type has been determined by the determination unit 53, is transported to the corresponding destination, based on the transport setting. A component such as an outlet unit or a storage unit to be a destination of a transported banknote serves as a discharge unit for discharging the banknote to a predetermined space.

As described above, the banknote handling apparatus 1 according to the present embodiment can perform the secondary recognition process based on the reading result of a serial number of a banknote, in addition to the primary recognition process based on the dimensions, optical features, magnetic features, etc., of the banknote. In the secondary recognition process, the type of the banknote related to the serial number is determined based on the serial number reading result, and the banknote is sorted to any of “fit note”, “unfit note”, “suspect note”, “counterfeit note”, “reject note”, etc. In addition, it is possible to select one of: determining the type of a banknote through only the primary recognition process; determining the type of a banknote through only the secondary recognition process; and determining the type of a banknote through both the primary recognition process and the secondary recognition process. Thus, various ways to handle banknotes based on serial numbers can be realized.

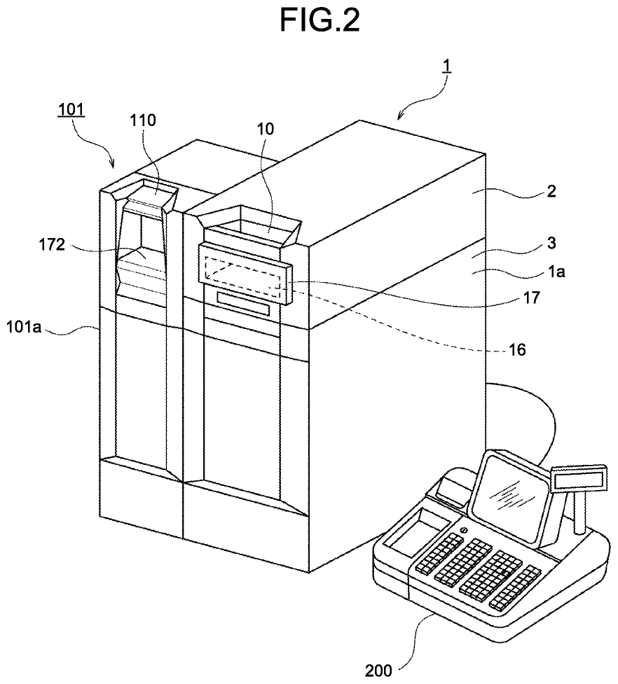

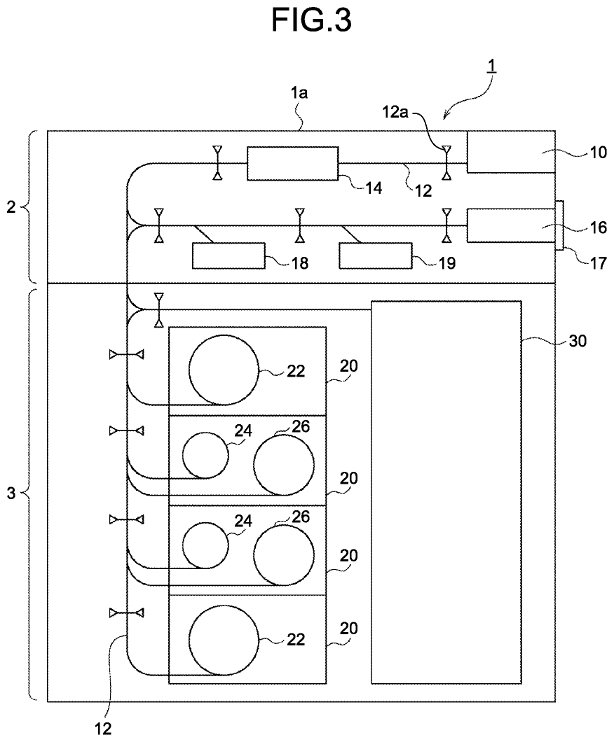

Next, a specific configuration of the banknote handling apparatus 1 and banknote handling performed by the banknote handling apparatus 1 will be described. FIG. 2 is a perspective view of an outer appearance of a money handling system including the banknote handling apparatus 1. FIG. 3 is a schematic diagram showing an internal configuration of the banknote handling apparatus 1.

The money handling system including the banknote handling apparatus 1 is installed in a store such as a supermarket or a convenience store, and is used for depositing, dispensing, and the like of banknotes and coins. As shown in FIG. 2, the money handling system includes the banknote handling apparatus 1 and a coin handling apparatus 101 arranged side by side in the horizontal direction. For example, a POS register 200 communicably connected to the banknote handling apparatus 1 is used as a management device that manages the banknote handling apparatus 1 and the coin handling apparatus 101.

The configuration of the banknote handling apparatus 1 will be described. The right side of a housing 1a shown in FIG. 3 is the front side of the banknote handling apparatus 1. The banknote handling apparatus 1 including the housing 1a having an almost rectangular-parallelepiped shape is divided into an upper unit 2 and a lower unit 3. The upper unit 2 has, at a front-side upper portion thereof, a banknote inlet unit 10 in which banknotes to be deposited are inserted. The banknote inlet unit 10 feeds the inserted banknotes one by one into inside the housing 1a. The banknotes fed into the housing 1a are transported along a transport path by a transport unit 12.

Banknote detection sensors 12a for detecting banknotes being transported by the transport unit 12 are provided at a plurality of points of the transport path. For example, each banknote detection sensor 12a detects a banknote being transported along the transport path when light being transmitted and received between a light transmitter and a light receiver is cut off by the banknote. The banknote handling apparatus 1 recognizes the position of a banknote in the transport path, based on banknote detection information from each banknote detection sensor 12a, acquires feature information and an image of the banknote, and controls transport of the banknote.

A recognition sensor unit 14 for acquiring feature information and images of banknotes by using various sensors is provided along the transport path. The recognition sensor unit 14 acquires dimensions, feature information such as optical features and magnetic features, and images of banknotes, by using a plurality of types of sensors such as a line sensor, a thickness sensor, and a magnetic sensor. The recognition sensor unit 14 enables acquisition of dimensions of banknotes, reflected images, transmitted images, reflection spectrums, absorption spectrums, signals representing a magnetization direction and a magnetization state, and the like. Using the images and signals acquired in the recognition sensor unit 14, the primary recognition unit 51 performs the primary recognition process and the secondary recognition unit 52 performs the secondary recognition process.

At an end of the transport path on the apparatus front side, a banknote outlet unit 16 for discharging banknotes to the outside of the apparatus is connected. The banknote outlet unit 16 is provided with a shutter unit 17 for opening and closing a shutter. The shutter is usually closed. When banknotes discharged into the banknote outlet unit 16 are to be taken out from the apparatus, the shutter unit 17 opens the shutter to allow the banknotes to be taken out.

A first storage unit 18 and a second storage unit 19 are connected to the transport path in the upper unit 2. The first storage unit 18 and the second storage unit 19 receive banknotes transported through the transport path and store the banknotes therein. The transport path, through which the transport unit 12 transports the banknotes, extends from the upper unit 2 to the lower unit 3 so that the banknotes can be transported between the upper unit 2 and the lower unit 3. A plurality of tape-reel type storage/feeding units 20 are connected to the transport path in the lower unit 3. Each tape-reel type storage/feeding unit 20 receives the banknotes transported through the transport path, and stores the banknotes therein. Each storage/feeding unit 20 feeds the banknotes being stored therein one by one to the transport path. Two of the four storage/feeding units 20 each have one drum 22 therein. When storing the banknotes, the storage/feeding unit 20 receives the banknotes transported from the transport path, one by one between a pair of tapes. Then, the tapes sandwiching the banknotes therebetween are wound on the drum 22 and stored. When feeding the banknotes being stored to the transport path, the drum 22 rotates in a direction opposite to the direction in which the banknotes were stored. Then, the banknotes sandwiched between the pair of tapes are fed one by one to the transport path. The remaining two storage/feeding units 20 each have two drums 24 and 26 having different maximum banknote storage capacities. Storage and feeding of banknotes by the drums 24 and 26 are similar to those by the drum 22. The tapes to be wound by the two drums 24 and 26 have different lengths. When storing banknotes of the same denomination, the maximum storage number of banknotes on the drum 26 is greater than that on the drum 24. The types of banknotes to be stored on the drums 22, 24, and 26 of the respective storage/feeding units 20 can be set in advance. For example, six types of banknotes at maximum can be stored by types in the four storage/feeding units 20 by assigning each type to the drums 22, 24, and 26 of the four storage/feeding units 20.

A collection unit 30 is connected to the transport path in the lower unit 3. The collection unit 30 can be used for collecting banknotes stored in the respective storage/feeding units 20. Further, the collection unit can also be used for storing banknotes whose types are not assigned to the storage/feeding units 20, overflow banknotes that have not been stored in the corresponding storage/feeding unit 20 because the unit 20 is full, and the like.

As shown in FIG. 2, the coin handling apparatus 101 is provided with an almost rectangular-parallelepiped shaped housing 101a, a coin inlet unit 110 in which coins to be deposited are inserted, and a coin outlet unit 172 from which coins stored in the apparatus are discharged and dispensed to the outside. Provided inside the housing 101a are: a processing unit that recognizes coins fed from the coin inlet unit 110 into inside the housing 101a; a plurality of storage/feeding units that store the recognized coins by denominations in depositing process and feed out the stored coins in dispensing process; a collection box used as an overflow coin storage unit; and the like. In the depositing process, the coin handling apparatus 101 feeds the coins inserted in the coin inlet unit 110 into inside the apparatus, recognizes and counts the coins, and stores the coins in the storage/feeding units or the collection box. In the dispensing process, the coins fed out from the respective storage/feeding units are discharged into the coin outlet unit 172.

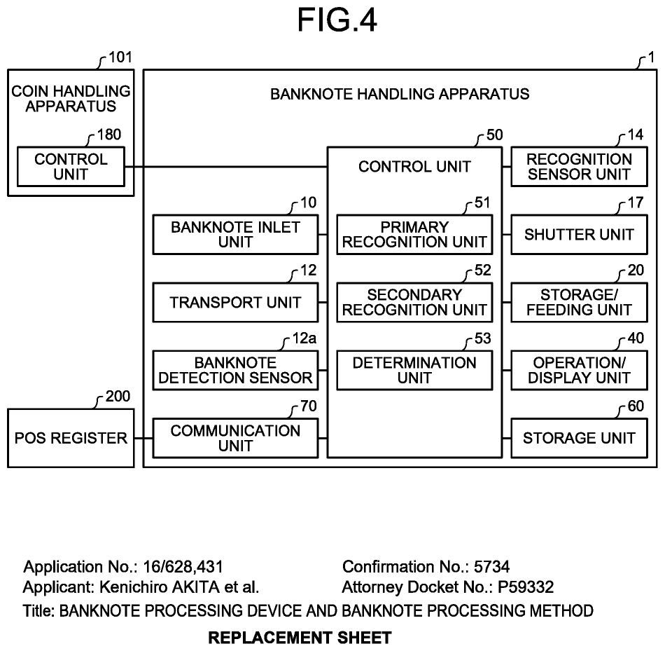

Next, the schematic functional configuration of the money handling system will be described. FIG. 4 is a block diagram schematically showing the functional configuration of the money handling system. As shown in FIG. 4, the banknote inlet unit 10, the transport unit 12, the banknote detection sensor 12a, the recognition sensor unit 14, the shutter unit 17, and the respective storage/feeding units 20 are connected to a control unit 50. An operation/display unit 40, a memory unit 60, and a communication unit 70 are also connected to the control unit 50. Upon receiving a signal of a banknote detection result from each banknote detection sensor 12a, the control unit 50 controls the banknote inlet unit 10, the transport unit 12, the recognition sensor unit 14, the shutter unit 17, the storage/feeding unit 20, etc.

The coin handling apparatus 101 is provided with a control unit 180 for controlling the components of the coin handling apparatus 101. The control unit 180 is communicably connected to the control unit 50 of the banknote handling apparatus 1. The control unit 50 of the banknote handling apparatus 1 is communicably connected to an external device such as the POS register 200 via the communication unit 70.

The operation/display unit 40 of the banknote handling apparatus 1 is implemented as a touch panel type liquid crystal display provided at the front surface or the upper surface of the housing 1a, for example. The operation/display unit 40 enables an operator to check the banknote handling state in the banknote handling apparatus 1, the coin handling state in the coin handling apparatus 101, the inventory number of banknotes, for each denomination, stored in each storage/feeding unit 20 in the banknote handling apparatus 1, the inventory number of coins, for each denomination, stored in each storage/feeding unit in the coin handling apparatus 101, and the like. By operating the operation/display unit 40, the operator can input various kinds of information to the control unit 50 of the banknote handling apparatus 1 and to the control unit 180 of the coin handling apparatus 101. By operating the operation/display unit 40, the operator can make an instruction to start banknote handling or the like, and can prepare, select, and change the settings for performing recognition and transport of banknotes.

The memory unit 60 is implemented as a nonvolatile semiconductor memory, for example. The memory unit 60 stores therein information such as the banknote handling history, the coin handling history, the inventory amount of banknotes for each denomination, and the inventory amount of coins for each denomination. Further, the memory unit 60 stores therein the settings for performing recognition and transport of banknotes.

The control unit 50 includes the primary recognition unit 51, the secondary recognition unit 52, and the determination unit 53. The primary recognition unit 51 performs the primary recognition process of recognizing a banknote based on the dimension, optical features, magnetic features, etc., of the banknote, thereby determining the type of the banknote. The secondary recognition unit 52 performs the secondary recognition process of recognizing the banknote based on the serial number of the banknote, thereby determining the type of the banknote. The banknote type determined by the primary recognition unit 51 and the banknote type determined by the secondary recognition unit 52 are input to the determination unit 53. The determination unit 53 performs determination based on the settings of the recognition processes to finally determine the type of the banknote.

In the banknote depositing process, banknotes to be deposited are inserted in the banknote inlet unit 10. The banknotes are fed out one by one from the banknote inlet unit 10 into inside the apparatus. The banknote is transported along the transport path by the transport unit 12. The recognition sensor unit 14 acquires, from the banknote being transported along the transport path, banknote feature information required for the primary recognition process, a banknote image required for the secondary recognition process, and the like. The banknote feature information and the banknote image acquired by the recognition sensor unit 14 are input to the control unit 50. The primary recognition unit 51 and the secondary recognition unit 52 perform the respective recognition processes by using the banknote feature information, the banknote image, and the like acquired in the recognition sensor unit 14. When the type of the banknote has been determined based on the recognition results, the banknote is transported to a destination corresponding to the determined type.

The banknote handling apparatus 1 executes at least one of the primary recognition process by the primary recognition unit 51 and the secondary recognition process by the secondary recognition unit 52 in accordance with the settings prepared in advance. Since the content of the primary recognition process performed by the primary recognition unit 51 is similar to the banknote recognition process performed by the conventional device, detailed description thereof will be omitted. Hereinafter, the case of performing only the secondary recognition process and the case of performing both the primary recognition process and the secondary recognition process, will be specifically described.

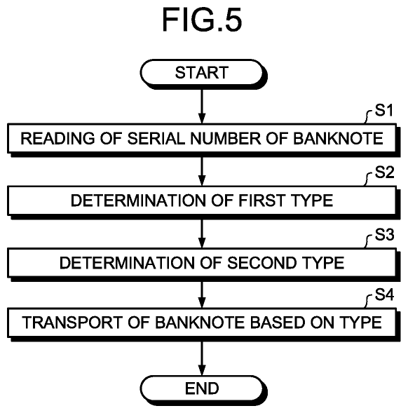

FIG. 5 is a flowchart showing a process of determining the type of a banknote through the secondary recognition process. First, the secondary recognition unit 52 reads the serial number of a banknote (step S1). Specifically, the secondary recognition unit 52 executes a character recognition process for the serial number by using the image of the banknote captured by the line sensor of the recognition sensor unit 14. When a plurality of serial numbers are printed on the banknote, the secondary recognition unit 52 executes the character recognition process for all the serial numbers. In the character recognition process, when there is a digit at which a character cannot be ascertained among a plurality of digits forming the serial number, the secondary recognition unit 52 assigns a predetermined mark to this digit. For example, a question mark “?” is assigned to each of uncertain digits at which characters could not be ascertained.

When reading of the serial number has been ended, the secondary recognition unit 52 determines the type (first type) of the banknote related to the serial number, based on the serial number reading result (step S2). Then, based on the first type, the secondary recognition unit 52 determines the type (second type) of the banknote related to authenticity and fitness (step S3). The secondary recognition unit 52 determines the second type of the banknote, based on the first type and on priority orders set for the second types. The first types, the second types corresponding to the first types, and the priority orders of the second types are set in advance. These settings are stored in the memory unit 60.

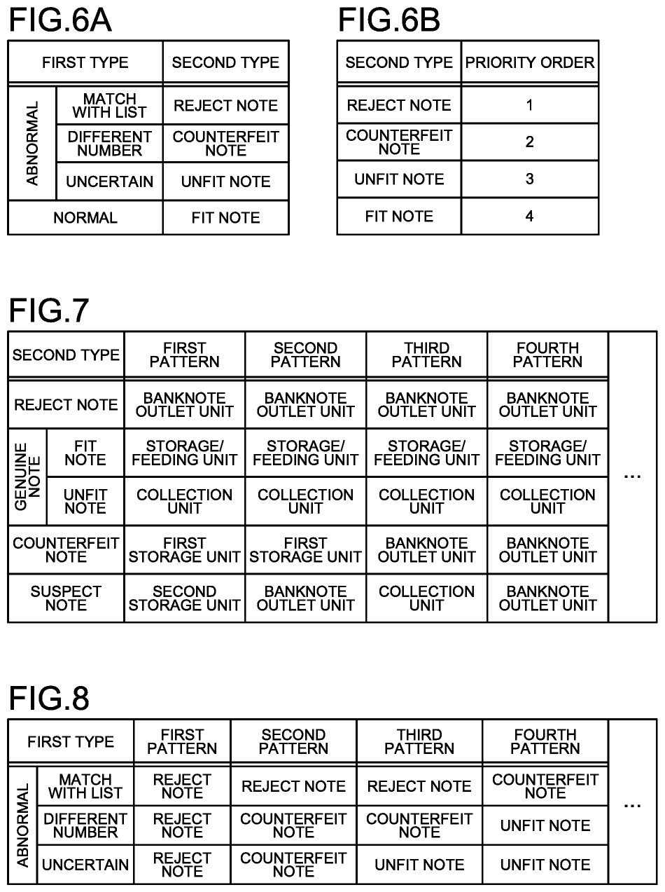

FIGS. 6A and 6B show examples of settings used in the secondary recognition process. FIG. 6A shows an example of setting of correspondence between the types (first types) of banknotes related to serial numbers and the types (second types) of banknotes related to authenticity and fitness. FIG. 6B shows an example of setting of priority orders of the second types. If a plurality of different second types become candidates with respect to one banknote when the secondary recognition unit 52 determines the second type of the banknote or when the determination unit 53 finally determines the second type of the banknote, the priority setting is used for determining the second type of the banknote.

A serial number list, on which serial numbers satisfying a predetermined condition are registered, is stored in advance in the memory unit 60. The secondary recognition unit 52 collates the serial number read from the banknote with the serial number list. When the serial number read from the banknote matches any of the serial numbers on the serial number list, the secondary recognition unit 52 determines that the type (first type) of the banknote related to the serial number is “match with list” shown in FIG. 6A. Then, based on the setting shown in FIG. 6A, the secondary recognition unit 52 determines that the type (second type) of this banknote related to authenticity and fitness is “reject note”. When a plurality of serial numbers are assigned to one banknote, the first type of this banknote is determined to be “match with list” if at least one of the serial numbers read from the banknote matches any of the serial numbers on the serial number list.

If at least one of a plurality of serial numbers assigned to one banknote is different from the other serial numbers, the secondary recognition unit 52 determines that the type (first type) of this banknote related to the serial number is “different number” shown in FIG. 6A, and determines that the type (second type) of this banknote related to authenticity and fitness is “counterfeit note”. For example, when two serial numbers printed on one banknote are compared, corresponding digits are successively compared between the two serial numbers each consisting of a plurality of digits. If there is at least one mismatch of the digits, the first type of this banknote is determined to be “different number”.

As for an uncertain digit at which a character could not be ascertained in the character recognition process, handling of this digit can be changed by setting. Specifically, it is possible to select either of regarding the uncertain digit to match all the characters and regarding the uncertain digit to match none of the characters. For example, when the uncertain digit is regarded to match none of the characters, if at least one of the plurality of serial numbers compared includes an uncertain digit, the first type of this banknote is determined to be “different number”.

If the plurality of serial numbers are read from the banknote and at least one of these serial numbers includes an uncertain digit, the secondary recognition unit 52 determines that the type (first type) related to the serial number of this banknote is “uncertain” shown in FIG. 6A. Then, the secondary recognition unit 52 determines that the type (second type) related to authenticity and fitness of this banknote is “unfit note”.

It can be set that the “match with list”, “different number”, and “uncertain” are classified into a type of “abnormal” as shown in FIG. 6A. Meanwhile, if the type (first type) of a banknote related to the serial number corresponds to none of “match with list”, “different number”, and “uncertain”, the secondary recognition unit 52 determines that the type (first type) of this banknote is “normal” shown in FIG. 6A, and determines that the type (second type) of this banknote related to authenticity and fitness is “fit note”.

When the first type corresponds to any one of “match with list”, “different number”, and “uncertain”, the second type is determined to be “reject note”, “counterfeit note”, or “unfit note” according to the setting shown in FIG. 6A. Specifically, the second type of a banknote whose first type corresponds to “match with list” is determined to be “reject note”. The second type of a banknote whose first type corresponds to “different number” is determined to be “counterfeit note”. The second type of a banknote whose first type corresponds to “uncertain” is determined to be “unfit note”.

When the second type of one banknote corresponds to two or more types among “reject note”, “counterfeit note”, “unfit note”, and “fit note”, the second type of this banknote is determined according to the priority setting shown in FIG. 6B. Specifically, for example, when the first type of one banknote corresponds to both “different number” and “uncertain”, the second type of this banknote is either “counterfeit note” or “unfit note”. In this case, since the order of the priority of “counterfeit note” is higher than the order of the priority of “unfit note” as shown in FIG. 6B, the secondary recognition unit 52 determines the second type of this banknote to be “counterfeit note”. Likewise, for example, when the first type of one banknote corresponds to all of “match with list”, “different number”, and “uncertain”, the secondary recognition unit 52 determines the second type of this banknote to be “reject note” according to the priority orders.

After the secondary recognition unit 52 has determined the second type of the banknote, the banknote is transported to the corresponding destination, based on transport settings prepared in advance (FIG. 5, step S4). FIG. 7 shows examples of patterns prepared as the transport settings. For example, through operation on the operation/display unit 40, a plurality of patterns shown in FIG. 7 are prepared in advance as the transport settings representing correspondence between banknote types and transport destinations. The prepared patterns are stored in the memory unit 60. Before banknote handling is started, a pattern to be used as transport setting is selected through operation on the operation/display unit 40. Thus, the banknote is transported to the corresponding destination, based on the selected pattern, i.e., transport setting, and on the second type of the banknote determined by the secondary recognition unit 52.

For example, when the first pattern shown in FIG. 7 is selected, a banknote whose first type corresponds to “match with list” and whose second type is determined to be “reject note” is transported to the banknote outlet unit 16. Likewise, a banknote whose second type is determined to be “fit note” is transported to the storage/feeding unit 20, a banknote whose second type is determined to be “unfit note” is transported to the collection unit 30, and a banknote whose second type is determined to be “counterfeit note” is transported to the first storage unit 18. When other patterns such as the second pattern are selected, banknotes are transported to destinations set for the respective patterns.

As for the setting shown in FIG. 6A, a plurality of patterns may be prepared in advance to allow selection of a pattern to be used. FIG. 8 shows an example of patterns prepared as settings for the secondary recognition process. For example, through operation on the operation/display unit 40, a plurality of patterns shown in FIG. 8, representing correspondence between first types and second types, are prepared in advance. The prepared patterns are stored in the memory unit 60. Before banknote handling is started, a pattern to be used as setting for the secondary recognition process is selected through operation on the operation/display unit 40. Thus, the type of a banknote is determined based on the selected pattern.

For example, when the third pattern shown in FIG. 8 is selected, this pattern corresponds to the setting shown in FIG. 6A, and the second type is determined based on the first type as described above. Meanwhile, for example, when the first pattern is selected, the second type of a banknote is determined to be “reject note” regardless of which of “match with list”, “different number”, and “uncertain” the first type of the banknote corresponds to. Likewise, when other patterns are selected, the types of banknotes are determined based on the respective patterns.

The priority setting is not limited to that shown in FIG. 6B, and a plurality of patterns may be prepared in advance to allow selection of a pattern to be used. In the priority setting shown in FIG. 6B, the priority orders are assigned to the second types of banknotes. However, the priority setting method is not limited thereto, and priority orders may be assigned to the first types of banknotes. For example, priority setting, in which priority orders are assigned respectively to “match with list”, “different number”, “uncertain”, and “normal” representing the first types, may be used. In this case, if one banknote corresponds to a plurality of first types, one of the first types is selected based on the priority setting, whereby the second type of the banknote can be determined.

For example, in the example shown in FIG. 6A, priority orders are set in the order of “match with list”, “different number”, “uncertain”, and “normal”. When the type (first type) of a banknote related to the serial number corresponds to both “different number” and “uncertain”, the secondary recognition unit 52 determines the first type to be “different number” having the higher priority order, and determines the second type of the banknote to be “counterfeit note”. Likewise, for example, when the first type corresponds to all of “match with list”, “different number”, and “uncertain”, the secondary recognition unit 52 determines the first type to be “match with list” based on the priority orders, and determines the second type to be “reject note”. In the example shown in FIG. 6A, when the priority orders of the first types are set in the order of “match with list”, “different number”, “uncertain”, and “normal”, this setting means that the priority orders of the second types are set in the order of “reject note”, “counterfeit note”, “unfit note”, and “fit note”. As a result, banknotes are handled in a similar manner to that for the case of using the priority setting shown in FIG. 6B.

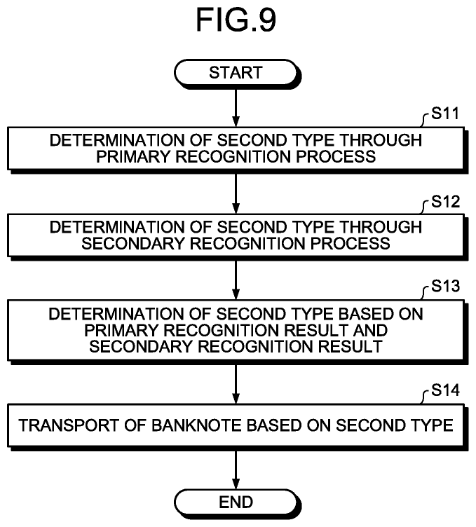

Next, the case of executing both the primary recognition process and the secondary recognition process will be described. FIG. 9 is a flowchart showing a process of determining the type (second type) of a banknote related to authenticity and fitness through the primary recognition process and the secondary recognition process. First, the primary recognition unit 51 executes the primary recognition process based on feature information of a banknote acquired in the recognition sensor unit 14, to determine the second type of the banknote (step S11). Specifically, after recognizing the denomination of the banknote, the primary recognition unit 51 determines which of a fit note, an unfit note, a counterfeit note, and a reject note, the banknote is. When the recognized object is a sheet, such as a coupon, other than banknotes, this sheet is determined to be a reject note. The primary recognition unit 51 inputs, to the determination unit 53, the second type of the banknote determined through the primary recognition process.

Subsequently, the secondary recognition unit 52 executes the secondary recognition process based on a reading result of the serial number of the banknote, to determine the second type of the banknote (step S12). Specifically, the secondary recognition unit 52 executes a character recognition process for the serial number by using an image of the banknote acquired by the recognition sensor unit 14. When a plurality of serial numbers are printed on the banknote, all the serial numbers are subjected to the character recognition process. In the character recognition process, if a plurality of digits forming the serial number includes an uncertain digit at which a character cannot be ascertained, a predetermined mark such as “?” is assigned to this digit. Then, the secondary recognition unit 52 determines the type (first type) of the banknote related to the serial number, based on the serial number reading result, and then determines the second type of the banknote based on the first type. These processes are similar to the processes in steps S1 to S3 shown in FIG. 5 having been described with reference to FIGS. 6 to 8. The secondary recognition unit 52 inputs, to the determination unit 53, the second type of the banknote determined through the secondary recognition process.

The second type of the banknote determined in the primary recognition process and the second type of the banknote determined in the secondary recognition process are input to the determination unit 53. At this time, the second type of the banknote determined in the primary recognition process may be changed due to influence of the second type of the banknote determined in the secondary recognition process. Therefore, the determination unit 53 executes the final determination based on both the second type of the banknote determined in the primary recognition process and the second type of the banknote determined in the secondary recognition process, to determine the second type of the banknote (step S15). This process will be described later in detail.

The banknote whose second type has been determined is transported to the corresponding destination, based on the transport setting (step S14), and the banknote handling ends. For example, when the first pattern shown in FIG. 7 is selected as the transport setting, the control unit 50 refers to the first pattern and recognizes the transport destination corresponding to the second type of the banknote finally determined by the determination unit 53. Then, the control unit 50 controls the transport unit 12 to transport the banknote to the recognized destination.

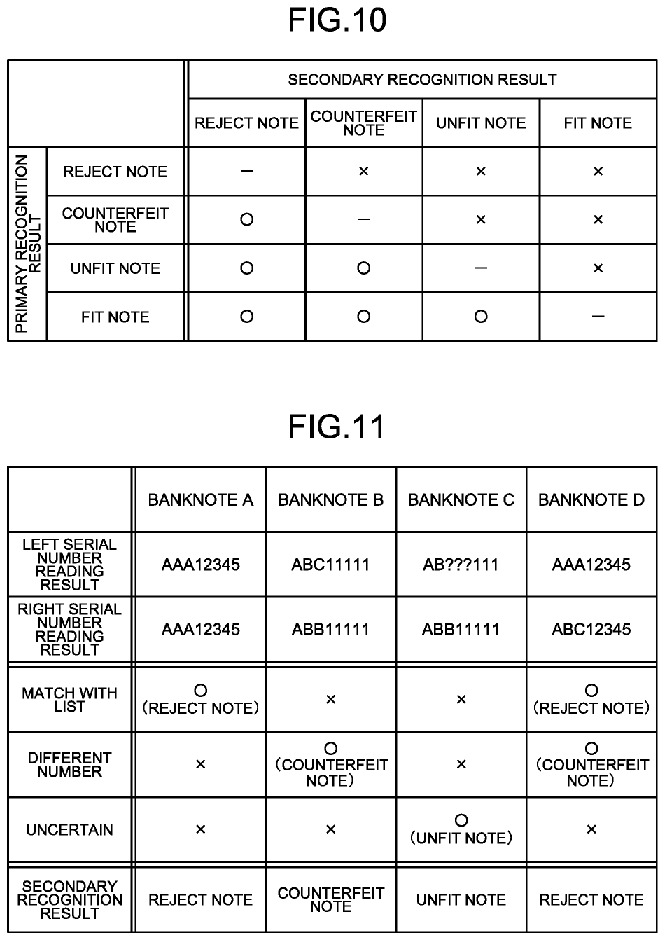

Next, the method of determining the second type of the banknote, which is performed in step S13 in FIG. 9, will be described. There are cases where the second type of the banknote determined in the primary recognition process is influenced by the second type of the banknote determined in the secondary recognition process and finally changed to another type, and where the second type is not influenced and not changed to another type. FIG. 10 shows a relationship between the second type determination result obtained in the primary recognition process and the second type determination result obtained in the secondary recognition process. In FIG. 10, the mark “0” indicates that the second type of the banknote determined in the primary recognition process is changed to the second type of the banknote determined in the secondary recognition process. Meanwhile, the mark “x” indicates that the second type of the banknote determined in the primary recognition process is not influenced by the second type of the banknote determined in the secondary recognition process. In the case of “x”, the second type of the banknote determined in the primary recognition process is the final second type of the banknote. In FIG. 10, the mark “-” indicates that the second type of the banknote determined in the primary recognition process is identical to the second type of the banknote determined in the secondary recognition process and therefore the second type of the banknote is not changed.

For example, as shown in FIG. 10, when the second type of the banknote determined in the primary recognition process is “reject note” and the second type of the banknote determined in the secondary recognition process is also “reject note” (“-” in FIG. 10), the second type of the banknote is not changed. Also, when the second type of the banknote determined in the secondary recognition process is any of “counterfeit note”, “unfit note”, and “fit note” (“x” in FIG. 10), the second type of the banknote is not changed. In other words, a banknote having been determined to be “reject note” in the primary recognition process is not changed to “counterfeit note”, “unfit note”, or “fit note” due to an influence by the secondary recognition process.

For example, when the second type of the banknote determined in the primary recognition process is “counterfeit note” and the second type of the banknote determined in the secondary recognition process is also “counterfeit note”, the second type of the banknote is not changed. Also, when the second type of the banknote determined in the secondary recognition process is “unfit note” or “fit note”, the second type of the banknote is not changed. However, when the second type of the banknote determined in the secondary recognition process is “reject note”, the second type of this banknote is finally determined to be “reject note”. In other words, a banknote that has been determined to be “counterfeit note” in the primary recognition process is not changed to “unfit note” or “fit note”, but may be changed to “reject note”, due to an influence of the secondary recognition process.

Likewise, a banknote that has been determined to be “unfit note” in the primary recognition process is not changed to “fit note”, but may be changed to “reject note” or “counterfeit note”, due to an influence of the secondary recognition process. Meanwhile, a banknote that has been determined to be “fit note” in the primary recognition process may be changed to “reject note”, “counterfeit note”, or “counterfeit note” due to an influence of the secondary recognition process. Thus, FIG. 10 defines priority orders among the second types of banknotes according to the primary recognition result and the second types of banknotes according to the secondary recognition result.

Next, examples of specific serial numbers will be described. FIG. 11 shows examples of second types of banknotes, each having two serial numbers printed at left and right sides, determined in the secondary recognition process. In FIG. 11, among “match with list”, “different number”, and “uncertain” that are set in advance as the types (first types) related to the serial numbers, the mark “0” is assigned to the types to which the serial number reading result corresponds, while the mark “x” is assigned to the types to which the serial number reading result does not correspond. As for each first type with the mark “0”, the second type of the banknote determined based on this first type is represented in brackets.

The secondary recognition process is performed for two serial numbers of a banknote A. As a result, characters are ascertained at all the digits of the left and right serial numbers in the character recognition process. Therefore, the first type of the banknote A does not correspond to “uncertain” (“x” in FIG. 11). The left and right serial numbers obtained through the character recognition are identical to each other. Therefore, the first type of the banknote A does not correspond to “different number” (“x” in FIG. 11). The character-recognized serial number of the banknote A matches a serial number registered on the serial number list. Therefore, the first type of the banknote A corresponds to “match with list” (“0” in FIG. 11). Consequently, based on the setting shown in FIG. 6A, the secondary recognition unit 52 determines that the second type of the banknote A whose first type corresponds to “match with list” is “reject note”. The secondary recognition unit 52 inputs the second type, “reject note”, of the banknote A to the determination unit 53.

The secondary recognition process is performed for two serial numbers of a banknote B. As a result, characters are ascertained at all the digits of the left and right serial numbers in the character recognition process. Therefore, the first type of the banknote B does not correspond to “uncertain”. The character-recognized left and right serial numbers have different characters at the third digits. Therefore, the first type of the banknote B corresponds to “different number”. The character-recognized left serial number and right serial number do not match any of the serial numbers registered on the serial number list. Therefore, the first type of the banknote B is not “match with list”. Consequently, based on the setting shown in FIG. 6A, the secondary recognition unit 52 determines that the second type of the banknote B whose first type corresponds to “different number” is “counterfeit note”. The secondary recognition unit 52 inputs the second type, “counterfeit note”, of the banknote B to the determination unit 53.

The secondary recognition process is performed for two serial numbers of a banknote C. As a result, in the character recognition process, characters are ascertained at all the digits of the right serial number, but characters at the third to fifth digits of the left serial number cannot be ascertained. Thus, the third to fifth digits are regarded as uncertain digits and are assigned marks of “?”. Thus, the first type of the banknote C corresponds to “uncertain”. When the left and right serial numbers are compared to determine whether or not the serial numbers match, the uncertain digits may be regarded to match all the characters or may be regarded to match none of the characters. Since, according to the setting in this process, the uncertain digits are regarded to match all the characters, the left and right serial numbers of the banknote C are determined to be identical. Thus, the first type of the banknote C does not correspond to “different number”. The character-recognized left serial number and right serial number do not match any of the serial numbers registered on the serial number list. Therefore, the first type of the banknote C does not correspond to “match with list”. Consequently, based on the setting shown in FIG. 6A, the secondary recognition unit 52 determines that the second type of the banknote C whose first type corresponds to “uncertain” is “unfit note”. The secondary recognition unit 52 inputs the second type, “unfit note”, of the banknote C to the determination unit 53.

The secondary recognition process is performed for two serial numbers of a banknote D. As a result, characters are ascertained at all the digits of the left and right serial numbers in the character recognition process. Therefore, the first type of the banknote D does not correspond to “uncertain”. The character-recognized left and right serial numbers have different characters at the second digit. Therefore, the first type of the banknote D corresponds to “different number”. The character-recognized right serial number does not match any of the serial numbers registered on the serial number list, but the left serial number matches a serial number registered on the serial number list. Therefore, the first type of the banknote D is “match with list”. Consequently, based on the setting shown in FIG. 6A, the secondary recognition unit 52 determines that the second type of the banknote D, whose first type corresponds to both “match with list” and “different number”, is “reject note” or “counterfeit note”, and then refers to the priority setting shown in FIG. 6B. Then, the secondary recognition unit 52 determines that the second type of the banknote D is “reject note”, which has a higher priority order than “counterfeit note”. The secondary recognition unit 52 inputs the second type, “reject note”, of the banknote D to the determination unit 53.

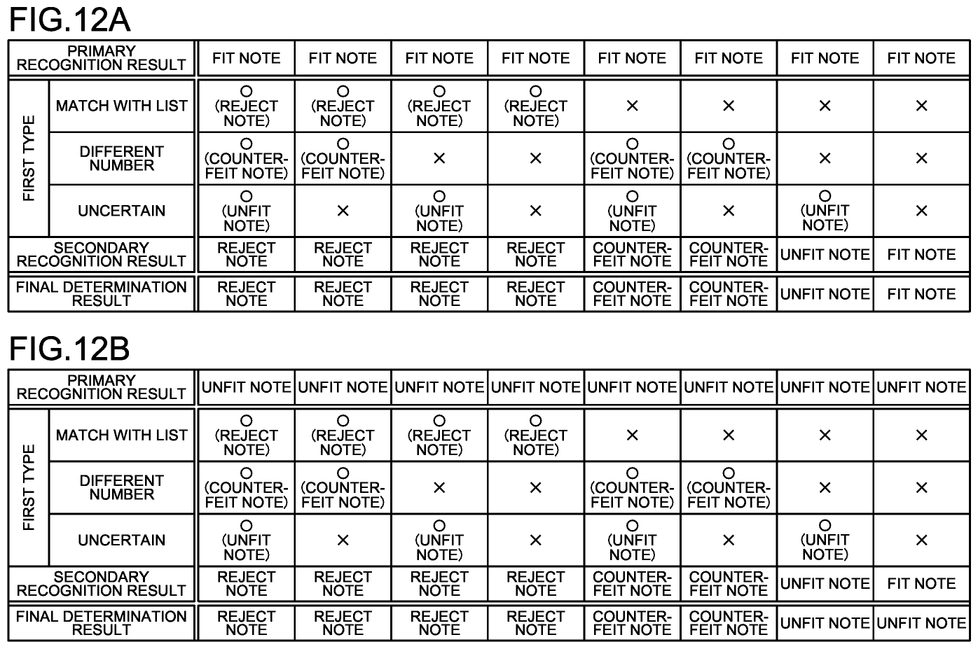

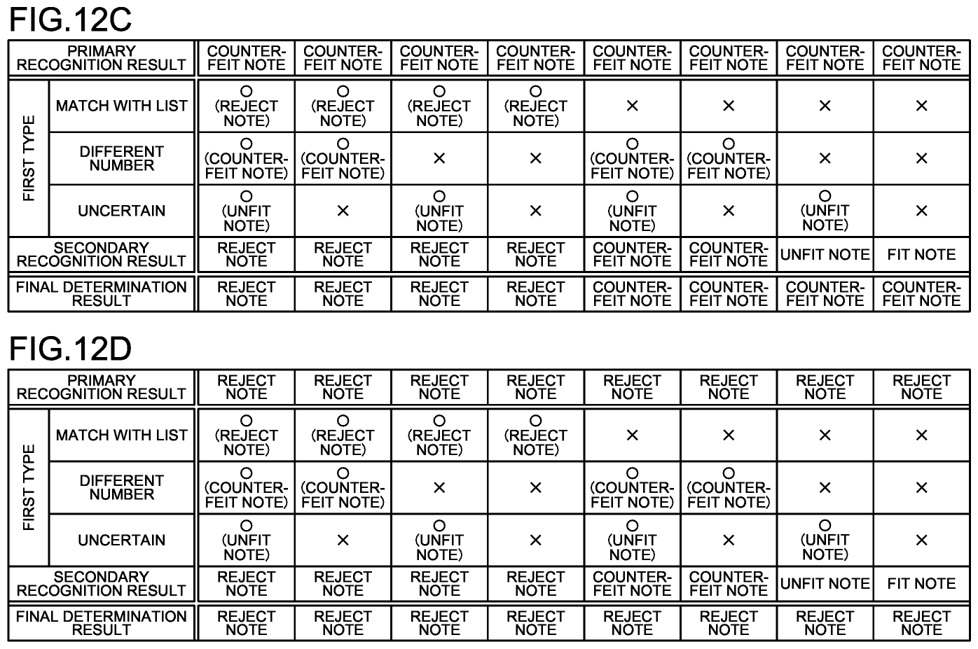

As described above, when the second type of the banknote determined in the secondary recognition process is input to the determination unit 53, the determination unit 53 performs the final determination based on the second type of the banknote determined in the primary recognition process and the second type of the banknote determined in the secondary recognition process, to determine the second type of the banknote. FIGS. 12A to 12D show the second types of banknotes finally determined based on the second types of the banknotes determined in the primary recognition process and the second types of the banknotes determined in the secondary recognition process.

FIG. 12A shows the second types of banknotes finally determined upon receiving the second types of the banknotes determined in the secondary recognition process, when the second types of the banknotes have been determined to be “fit note” in the primary recognition process. Likewise, FIGS. 12B to 12D show the second types of banknotes finally determined upon receiving the second types of the banknotes determined in the secondary recognition process, when the second types of the banknotes determined in the primary recognition process are “unfit note”, “counterfeit note”, and “reject note”, respectively.

In FIGS. 12A to 12D, “primary recognition result” indicates the second types of banknotes determined in the primary recognition process. “First type” indicates the types related to serial numbers determined based on the serial numbers read in the secondary recognition process. Specifically, among “match with list”, “different number”, and “uncertain” that are set in advance as the types (first types) related to the serial numbers of banknotes, the mark “0” is assigned to the types to which the serial number reading result corresponds, while the mark “x” is assigned to the types to which the serial number reading result does not correspond. As for each first type with the mark “0”, the second type of the banknote determined based on this first type is represented in brackets. “Secondary recognition result” indicates the second types of the banknotes finally determined based on the first types in the secondary recognition process. The settings to be used for the secondary recognition process are prepared in advance as shown in FIGS. 6A and 6B. In the secondary recognition process, the second types of the banknotes are determined based on the settings as described with reference to FIG. 11.

Upon receiving the second type of the banknote determined in the primary recognition process and the second type of the banknote determined in the secondary recognition process, the determination unit 53 performs the final determination based on the priority setting as shown in FIG. 6B, to determine the second type of the banknote. That is, the determination unit 53 compares the priority order of the second type based on the primary recognition result with the priority order of the second type based on the secondary recognition result, and determines the second type having the higher priority order as the final type of the banknote.

For example, when the banknotes A to D shown in FIG. 11 have been determined to be “fit note” in the primary recognition process, the banknotes A and D determined to be “reject note” in the secondary recognition process are finally determined to be “reject note” as shown in FIG. 12A. Meanwhile, the banknote B determined to be “counterfeit note” in the secondary recognition process is finally determined to be “counterfeit note”, and the banknote C determined to be “unfit note” in the secondary recognition process is finally determined to be “unfit note”.

When the banknotes A to D shown in FIG. 11 have been determined to be “unfit note” in the primary recognition process, the banknotes A and D determined to be “reject note” in the secondary recognition process are finally determined to be “reject note” as shown in FIG. 12B. The banknote B determined to be “counterfeit note” in the secondary recognition process is finally determined to be “counterfeit note”, and the banknote C determined to be “unfit note” in the secondary recognition process is finally determined to be “unfit note”.

When the banknotes A to D shown in FIG. 11 have been determined to be “counterfeit note” in the primary recognition process, the banknotes A and D determined to be “reject note” in the secondary recognition process are finally determined to be “reject note” as shown in FIG. 12C. The banknote B determined to be “counterfeit note” in the secondary recognition process is finally determined to be “counterfeit note”, and the banknote C determined to be “unfit note” in the secondary recognition process is finally determined to be “counterfeit note”.

When the banknotes A to D shown in FIG. 11 have been determined to be “reject note” in the primary recognition process, the banknotes A and D determined as “reject note”, the banknote B determined as “counterfeit note”, and the banknote C determined as “unfit note” in the secondary recognition process, are all finally determined to be “reject note” as shown in FIG. 12D.

As described above, in the banknote handling apparatus 1, the determination unit 53 performs final determination to determine the second type of a banknote, based on the second type of the banknote determined in the primary recognition process performed by the primary recognition unit 51 and on the second type of the banknote determined in the secondary recognition process performed by the secondary recognition unit 52. The final determination of the second type is performed based on the priority setting.

In the present embodiment, as shown in FIG. 9, the primary recognition process is followed by the secondary recognition process. However, the primary recognition process and the secondary recognition process may be performed in parallel. Alternatively, the second type of a banknote may be determined based on the features of the banknote, such as the dimension, optical features, magnetic features, and the type (first type) related to the serial number determined based on the serial number reading result, without distinguishing between the primary recognition process and the secondary recognition process. Specifically, for example, when the second type of the banknote has been determined based on the features of the banknote, such as the dimension, optical features, magnetic features, and the first type, if at least one feature that causes the second type of the banknote to be determined as “reject note” is obtained, the second type of this banknote is determined to be “reject note” regardless of the other features. Meanwhile, when a feature that causes the second type of the banknote to be determined as “reject note” is not obtained and at least one feature that causes the second type to be determined as “counterfeit note” is obtained, the second type of this banknote is determined to be “counterfeit note”. When a feature that causes the second type of the banknote to be determined as “reject note” or “counterfeit note” is not obtained and at least one feature that causes the second type to be determined as “unfit note” is obtained, the second type of this banknote is determined to be “unfit note”. When a feature that causes the second type of the banknote to be determined as “reject note”, “counterfeit note”, or “unfit note” is not obtained, the second type of this banknote is determined to be “fit note”. In this case, as described above, the first type of the banknote, such as “match with list”, “different number”, or “uncertain”, can be reflected in the determination of the second type.

Although four second types of banknotes, i.e., “reject note”, “counterfeit note”, “unfit note”, and “fit note”, are adopted in the above examples, the types of banknotes to be adopted as the second types and the number of the second types are not limited in particular. For example, three or less types or five or more types may be adopted as the second types. For example, “suspect note” may be added to the second types. Then, priority orders may be assigned in the order of “reject note”, “counterfeit note”, “suspect note”, “unfit note”, and “fit note”, and banknotes may be sorted into these five types. Further, fit notes may be sorted into ATM fit notes and teller fit notes. The “ATM fit note” is a type of a banknote that has minimum stain and damage and is available as a banknote to be dispensed from an automatic machine such as an ATM. The “teller fit note” is a type of a banknote that is more stained and damaged as compared to the “ATM fit note” but is less stained and damaged as compared to the “unfit note”, and is available as a banknote to be dispensed at a teller window.

In the above embodiment, the second type of a banknote is determined from among “reject note”, “counterfeit note”, and “unfit note” according to which one of “match with list”, “different number”, and “uncertain”, the first type of the banknote obtained through the secondary recognition process corresponds to. However, the first types obtained in the secondary recognition process, the number of the first types, and the second types corresponding to the first types are not limited to those described above.

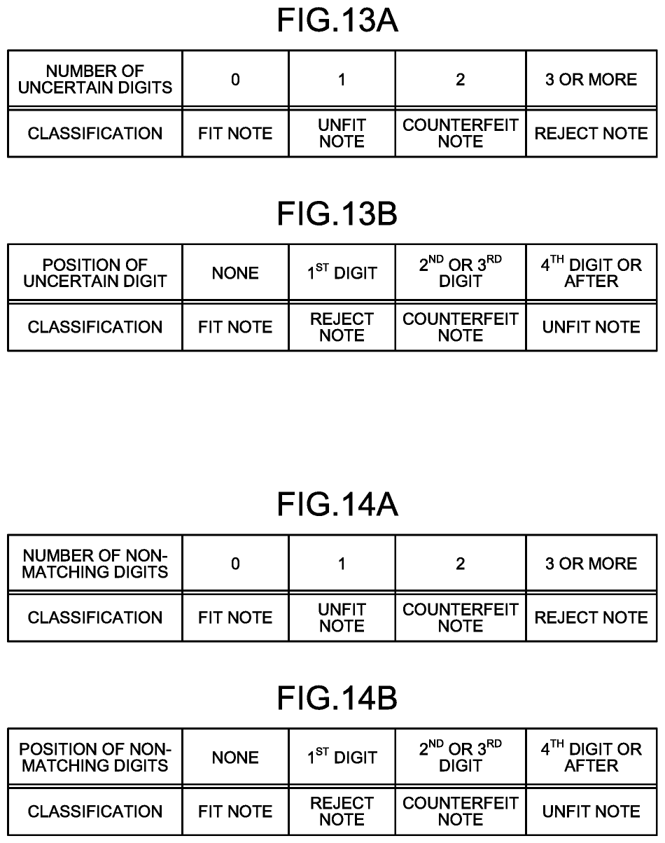

For example, it can be set that when the first type is “uncertain”, the degree of uncertainness of the serial number is classified in more detail based on the number or positions of uncertain digits, and the second type is determined according to the degree of uncertainness. FIGS. 13A and 13B illustrate examples of settings for determining the second type of a banknote based on the number and positions of uncertain digits. FIG. 13A shows the setting for determining the second type of a banknote based on the number of uncertain digits. FIG. 13B shows the setting for determining the second type of a banknote based on the positions of uncertain digits. As shown in FIG. 13A, it can be set that the second type of a banknote is determined based on how many digits have been determined to be “uncertain”, in other words, how many characters could not be recognized, in the serial number character recognition process. Further, as shown in FIG. 13B, it can be set that the second type of a banknote is determined based on what digit has been determined to be “uncertain” in the serial number character recognition process, in other words, based on the position of a digit at which a character could not be recognized in the serial number consisting of a plurality of digits.

It can be set that when the first type is “different number”, the degree of mismatch of a plurality of serial numbers is classified in more detail based on the number or positions of digits that have not matched in comparing the serial numbers, and the second type is determined based on the degree of mismatch. FIGS. 14A and 14B illustrate examples of settings for determining the second type of a banknote based on the number and positions of digits that have not matched in comparing the serial numbers. FIG. 14A shows the setting for determining the second type of a banknote based on the number of digits that have not matched in comparing the serial numbers. FIG. 14B shows the setting for determining the second type of a banknote based on the positions of digits that have not matched. As shown in FIG. 14A, it can be set that the second type of a banknote is determined based on how many digits have not matched, in other words, how many characters have not matched when the plurality of serial numbers obtained through character recognition were compared. Further, as shown in FIG. 14B, it can be set that the second type of a banknote is determined based on what digits have not matched, in other words, the position of digits at which characters have not matched between the serial numbers each consisting of a plurality of digits, when the plurality of serial numbers obtained through character recognition were compared.

Even when the setting shown in any of FIGS. 13A and 13B, and FIGS. 14A and 14B is adopted instead of the setting shown in FIG. 6A, the second type of a banknote can be determined based on the serial number reading result as described above. Further, a plurality of settings may be selectively used among the above settings. Even when the plurality of settings are used, the second type of a banknote can be determined as described above by use of setting of priority orders as shown in FIG. 6B.

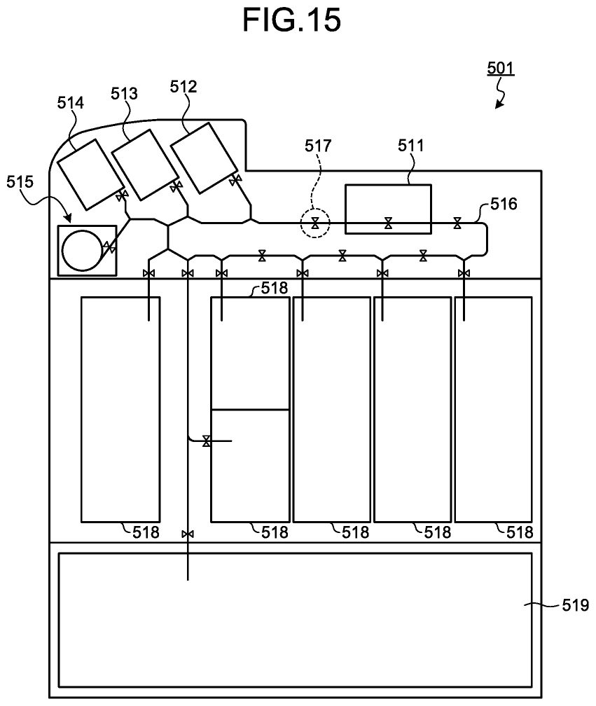

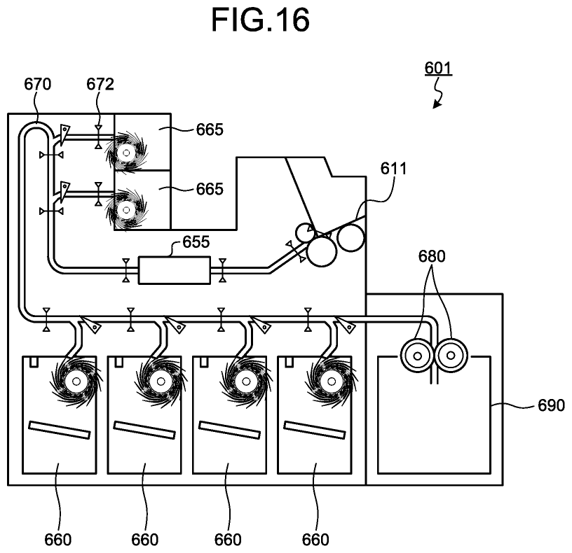

The configuration of the banknote handling apparatus for sorting banknotes by executing at least one of the primary recognition process and the secondary recognition process is not limited to the configuration shown in FIGS. 2 to 4. FIG. 15 shows an example of another banknote handling apparatus 501 capable of executing the secondary recognition process. FIG. 16 shows an example of still another banknote handling apparatus 601 capable of executing the secondary recognition process.

The banknote handling apparatus 501 shown in FIG. 15 includes a recognition/counting unit 511, an inlet 512, an outlet 513, a deposit reject port 514, a temporary storage unit 515, a transport unit 516, a banknote detection sensor 517, storage/feeding units 518, and a collection unit 519. The apparatus 501 further includes an operation unit, a display, a control unit, a memory unit, etc., which are not shown. Since the function and structure of the banknote handling apparatus 501 are described in, for example, Japanese Laid-Open Patent Publication No. 2011-198145, detailed description thereof will be omitted. The control unit controls the respective components, based on various settings stored in the memory unit. This enables determination of the type of a banknote, and handling of the banknote based on the determination result. Specifically, the functions and operations of the recognition sensor unit 14, the primary recognition unit 51, the secondary recognition unit 52, and the determination unit 53 can be implemented by the recognition/counting unit 511 and the control unit. From a banknote that is fed from the inlet 512 into inside the apparatus and is transported by the transport unit 516, the recognition/counting unit 511 acquires feature information and an image of the banknote. Then, based on settings prepared in advance, at least one of the primary recognition process and the secondary recognition process is executed to determine the type of the banknote as described above. Thus, the second type of the banknote can be determined, and the banknote can be transported to a destination according to the determination result. In the banknote handling apparatus 501, the transport destination of the banknote can be selected from among the outlet 513, the deposit reject port 514, the temporary storage unit 515, the storage/feeding unit 518, and the collection unit 519.

The banknote handling apparatus 601 shown in FIG. 16 includes a receptacle unit 611, a transport unit 670, a recognition/counting unit 655, reject units 665, stacking units 660, banknote detection sensors 672, a shredder 680, and a storage box 690. The apparatus 601 further includes an operation unit, a display, a control unit, a memory unit, etc. which are not shown. The shredder 680 shreds banknotes having been transported by the transport unit 670. The shredded banknotes are stored in the storage box 690. Since the structure of the banknote handling apparatus 601 is described in, for example, WO2017/014209, detailed description thereof will be omitted. The control unit controls the respective components, based on various settings stored in the memory unit. This enables determination of the type of a banknote, and handling of the banknote based on the determination result. Specifically, the functions and operations of the recognition sensor unit 14, the primary recognition unit 51, the secondary recognition unit 52, and the determination unit 53 can be implemented by the recognition/counting unit 655 and the control unit. From a banknote that is fed from the receptacle unit 611 into inside the apparatus and is transported by the transport unit 670, the recognition/counting unit 655 acquires feature information and an image of the banknote. Then, based on settings prepared in advance, at least one of the primary recognition process and the secondary recognition process is executed to determine the type of the banknote as described above. Thus, the second type of the banknote can be determined, and the banknote can be transported to a destination according to the determination result. In the banknote handling apparatus 601, the transport destination of the banknote can be selected from among the reject unit 665, the stacking unit 660, and the shredder 680.

As described above, the banknote handling apparatus according to the present embodiment is capable of executing at least one of the primary recognition process of recognizing a banknote based on the dimension, optical features, magnetic features, etc., of the banknote, and the secondary recognition process of recognizing a banknote based on a serial number read from the banknote.

In the secondary recognition process performed based on a plurality of serial numbers read from a banknote, the type (first type) of the banknote related to the serial numbers is determined based on, for example, an uncertain digit at which a character could not be ascertained, a result of comparison between the plurality of serial numbers, and/or a result of matching with a serial number list on which serial numbers satisfying a predetermined condition are registered. Then, based on the result of this determination, the type (second type) of the banknote related to authenticity and fitness can be determined. When correspondence between the first types and the various second types of banknotes such as “fit note”, “unfit note”, “counterfeit note”, “suspect note”, “reject note”, etc., is prepared in advance, the second type of a banknote can be determined from among these various types, based on the serial number reading result.

When both the primary recognition process and the secondary recognition process are executed, the second type of a banknote can be finally determined based on the second type of the banknote determined in the primary recognition process and the second type of the banknote determined in the secondary recognition process. When a plurality of first types based on the serial number reading result are associated with a plurality of second types related to authenticity and fitness, various ways to handle banknotes based on the serial numbers can be realized.

### INDUSTRIAL APPLICABILITY

As described above, the banknote handling apparatus and the banknote handling method according to the present invention are useful for meeting demands for banknote handling using serial numbers.

### DESCRIPTION OF THE REFERENCE CHARACTERS

1, 501, 601 Banknote handling apparatus
2 Upper unit
3 Lower unit
10 Banknote inlet unit
12, 516, 670 Transport unit
14 Recognition sensor unit
16 Banknote outlet unit
17 Shutter unit
18 First storage unit
19 Second storage unit
20, 518 Storage/feeding unit
30, 519 Collection unit
40 Operation/display unit
50 Control unit
51 Primary recognition unit
52 Secondary recognition unit
53 Determination unit
60 Memory unit
70 Communication unit
511, 655 Recognition/counting unit
512 Inlet
513 Outlet
514 Deposit reject port
515 Temporary storage unit
611 Receptacle unit
660 Stacking unit
665 Reject unit
680 Shredder
690 Storage box

1. A banknote handling apparatus comprising:
a recognition unit configured to read a serial number of a banknote; and
a control unit configured to determine a first type, of the banknote, related to the serial number, based on the serial number read by the recognition unit, and determine a second type, of the banknote, related to authenticity and fitness, based on the first type.

2. The banknote handling apparatus according to claim 1, further comprising:
a memory unit configured to store therein correspondence between a plurality of first types and a plurality of second types,
wherein the control unit is configured to determine a first type, among the plurality of first types stored in the memory unit, to which the banknote whose serial number has been read by the recognition unit corresponds, thereby determining the second type of the banknote.

3. The banknote handling apparatus according to claim 2, wherein
the memory unit is configured to further store therein priority orders of the first types, and
when the banknote whose serial number has been read by the recognition unit corresponds to a plurality of the first types, the control unit is configured to select one of the first types based on the priority orders, thereby determining the second type of the banknote.

4. The banknote handling apparatus according to claim 2, wherein
the memory unit is configured to further store therein priority orders of the second types, and
when the banknote whose serial number has been read by the recognition unit corresponds to a plurality of the first types so that the single banknote is sorted into a plurality of the second types, the control unit is configured to determine one of the second types based on the priority orders.

5. The banknote handling apparatus according to claim 1 further comprising an operation unit configured to set correspondence between the first types and the second types.

6. The banknote handling apparatus according to claim 1, wherein the first types include a type indicating that the serial number of the banknote matches a serial number included in a serial number list prepared in advance.

7. The banknote handling apparatus according to claim 1, wherein the first types include a type indicating that a plurality of serial numbers printed on a single banknote include a serial number different from the other serial numbers.

8. The banknote handling apparatus according to claim 1, wherein the first types include a type indicating that characters have not been ascertained at one or more digits of the serial number and the number or positions of the digits at which the characters are uncertain satisfies a predetermined condition.

9. The banknote handling apparatus according to claim 2, wherein the second types include a type indicating a genuine and fit note, a type indicating a genuine and unfit note, and a type indicating a counterfeit note.

10. The banknote handling apparatus according to claim 9, wherein the second types further include a type indicating a reject note.

11. The banknote handling apparatus according to claim 9, wherein the second types further include a type indicating a suspect note.

12. The banknote handling apparatus according to claim 1, wherein
the recognition unit is configured to further recognize a feature, of the banknote, other than the serial number, and
the control unit is configured to determine the second type of the banknote, based on the feature other than the serial number, the feature having been recognized by the recognition unit.

13. The banknote handling apparatus according to claim 12, wherein
when the second type determined based on the first type of the banknote is different from the second type determined based on the feature, of the banknote, other than the serial number, the control unit is configured to determine the second type of the banknote based on priority orders of the second types.

14. The banknote handling apparatus according to claim 12 or 13, wherein the control unit is configure to determine the second type based on the feature other than the serial number, and thereafter, perform a recognition process of determining the second type based on the first type.

15. The banknote handling apparatus according to claim 12, wherein the recognition unit is configured to recognize an optical feature, of the banknote, which is the feature other than the serial number by using a captured image of the banknote.

16. The banknote handling apparatus according to claim 1, further comprising:
an inlet unit in which banknotes are inserted;
a plurality of discharge units through which banknotes are discharged; and
a transport unit configured to transport banknotes, the transport unit connecting the insertion unit to the discharge units,
wherein the control unit is configured to control, based on the second type, the transport unit so as to transport the banknotes inserted from the inlet unit to any of the plurality of discharge units.

17. A banknote handling method of sorting banknotes for each type by a banknote handling apparatus, the method comprising:
reading a serial number of a banknote;
determining a first type of the banknote, based on the read serial number of the banknote; and
determining a second type, of the banknote, related to authenticity and fitness, based on the first type.
